(19) United States
(12) Patent Application Publication
(10) Pub. No.: US 2016/0142142 A1
(43) Pub. Date: May 19, 2016

(54) Spatial-Mode Multiplexing Optical Signal Streams Onto A Multimode Optical Fiber

(71) Applicant: Alcatel-Lucent USA Inc., Murray Hill, NJ (US)

(72) Inventors: Roland RYF, Aberdeen, NJ (US); Nicolas Fontaine, Keyport, NJ (US)

(73) Assignee: Alcatel-Lucent USA Inc., Murray Hill, NJ (US)

(21) Appl. No.: 14/230,937

(22) Filed: Mar. 31, 2014

Related U.S. Application Data
(60) Provisional application No. 61/950,803, filed on Mar. 10, 2014.

(51) Int. Cl. H04B 10/2581; H04Q 11/00

(52) U.S. Cl. CPC H04B 10/2581; H04Q 11/0005; H04Q 2011/0024

(57) ABSTRACT

An apparatus includes an optical spatial-mode multiplexer having a plurality of optical inputs and an optical output and an optical spatial-mode filter end-connected to the optical output of the optical spatial-mode multiplexer. The optical spatial-mode filter is configured to end-connect to a multimode optical fiber having a set of optical propagation modes and is configured to pass the optical modes of the set whose velocities in the multimode optical fiber are within a selected range and to block remaining ones of the optical modes of the set.

This application claims the benefit of U.S. Provisional Application No. 61/950,803, which was filed on Mar. 10, 2014.

### BACKGROUND

1. Technical Field

The inventions relate to optical spatial-mode multiplexers and methods and apparatus that use an optical spatial-mode multiplexer.

2. Related Art

This section introduces aspects that may be helpful to facilitating a better understanding of the inventions. Accordingly, the statements of this section are to be read in this light and are not to be understood as admissions about what is in the prior art or what is not in the prior art.

In some optical communication systems, optical communication signals are transmitted over a multimode optical fiber. Such a multimode optical fiber may support a high data transmission rate if the optical communication system uses optical spatial-mode multiplexing. In optical spatial-mode multiplexing, propagating modes having different lateral spatial intensity distributions may carry optical data signal streams, e.g., so that the total transmission capacity of the multimode optical fiber is higher than the transmission capacity of a single-mode optical fiber. In such an optical communication system, an optical receiver may use multiple-input multiple-output (MIMO) techniques and a digital signal processor (DSP) to demodulate data from the optical data streams received at the optical receiver.

### SUMMARY OF SOME EXAMPLE EMBODIMENTS

Unfortunately, some multimode optical fibers produce strong dispersion between different groups of spatial propagating modes. Herein, various exemplary apparatus, systems and methods are configured to selectively excite a portion of the propagating modes of a multimode optical fiber while not exciting others of the propagating modes. In particular, the exemplary apparatus may excite a proper subset of the propagating modes, whose phase velocities are in a preset range, e.g., all propagating modes with phase velocities in the preset range. Such a selective excitation of the propagating modes may enable the use of higher data rates and/or longer spans of multimode optical fiber link(s). Some such apparatus, systems, and methods may also provide adjustability to the number of excited propagating modes.

First embodiments provide an apparatus including an optical spatial-mode multiplexer having a plurality of optical inputs and an optical output and an optical spatial-mode filter end-connected to the optical output of the optical spatial-mode multiplexer. The optical spatial-mode filter is configured to end-connect to a multimode optical fiber having a set of optical propagation modes and is configured to pass the optical modes of the set whose velocities in the multimode optical fiber are within a selected range and to block remaining ones of the optical modes of the set.

In some first embodiments of the apparatus, the optical spatial-mode filter may include a segment of multimode optical fiber, which has tapered segments on both ends thereof. In some such embodiments, a central segment of the segment of multimode optical fiber has an optical core of smaller diameter than segments at both ends of the segment of multimode optical fiber.

Any of the first embodiments of the apparatus may further include an optical transmitter capable of transmitting optical signal streams to the multimode optical fiber, in parallel, via optical spatial-mode multiplexing. The optical transmitter includes an array of optical data modulators. Each optical data modulator of the array is optically connected to one of the optical inputs of the plurality. Some such embodiments further include the multimode optical fiber and an optical data receiver connected to receive the optical signal streams from the optical transmitter via the multimode optical fiber.

In some first embodiments of the apparatus, the optical spatial-mode filter may include an optical spatial-mode demultiplexer and an optical spatial-mode multiplexer connected in a back-to-back configuration.

In some first embodiments of the apparatus, the optical spatial-mode filter may be electrically reconfigurable to only pass optical modes of a second set, wherein the second set is a proper subset of the first set.

In any of the first embodiments, the optical spatial-mode filter may be configured to attenuate light of the remaining ones of the optical modes of the set by at least 10 decibels more than light of the optical modes of the set whose velocities in the multimode optical fiber are within the selected range.

Second embodiments provide a system including an optical transmitter and at least, one span of multimode optical fiber. The optical transmitter is configured to transmit optical signals via optical spatial-mode multiplexing. The at least, one span of multimode optical fiber has a near end connected to receive the transmitted optical signals from the optical transmitter and has a set of optical propagating optical modes. The system is configured to transmit optical signals via the multimode optical fiber over a proper subset of the set of propagating optical modes without significantly exciting those of the optical propagating modes outside the proper subset. The proper subset includes the optical propagating modes of the set having optical velocities in a selected interval.

In any of the second embodiments of the system, the optical transmitter may include an optical spatial-mode filter configured to attenuate light on the optical propagating modes outside the proper subset by at least 10 decibels more than light on the optical propagating modes in the proper subset.

In any of the second embodiments of the system, the optical data transmitter may include an optical spatial-mode filter configured to block light on the optical propagating modes outside of the proper subset.

In any of the second embodiments, the at least, one span of multimode optical fiber may have a far end-connected to transmit light therein to an all-optical processor that selectively attenuates light on the optical propagating modes outside the proper subset more than light on the optical propagating modes in the proper subset.

In any of the second embodiments of a system, the optical data transmitter may include an optical spatial-mode multiplexer serially connected to an optical spatial-mode filter.

In any of the second embodiments, the system may further include an optical data receiver connected to receive the transmitted optical signals via the multimode optical fiber and to perform multiple-input-multiple-output processing or equalization of light received from the multimode optical fiber based on only those of the spatial-optical modes in the proper subset.

Third embodiments provide a method that includes optical spatial-mode multiplexing, in parallel, a plurality of data-modulated optical carriers to produce an optical data-carrying beam. The method also includes optical spatial-mode filtering the optical data-carrying beam to remove light capable of exciting, at the end-face of a multimode optical fiber optical propagating modes with velocities outside of a preset range. The method includes transmitting the optical spatial-mode filtered, data-carrying beam to the end-face to excite optical propagating modes of the multimode optical fiber having velocities in the preset range.

In any of the third embodiments, the method may further include performing optical spatial-mode filtering of the transmitted, optical spatial-mode filtered, data-carrying beam after said transmitted, optical spatial-mode filtered data-carrying beam bean has traversed one or more spans of the multimode optical fiber. The performing may be configured to remove light carried by the optical propagating modes with velocities outside of a preset range.

In any of the third embodiments, the method may further include optical spatial-mode demultiplexing the transmitted, optical spatial-mode filtered, data-carrying light beam and performing equalization or MIMO processing of light beams produced by the optically spatial-mode demultiplexing.

### BRIEF DESCRIPTION OF THE DRAWINGS

FIG. 1 is a block diagram illustrating an optical apparatus for performing optical spatial-mode multiplexing;

FIG. 2 illustrates a refractive-index profile of a cross section through an optical fiber to which some embodiments of the optical apparatus of FIG. 1 may transmit spatial-mode multiplexed light;

FIG. 3 illustrates impulse responses of one example of a multimode optical fiber to which some embodiments of the optical apparatus of FIG. 1 may transmit spatial-mode multiplexed light;

FIG. 4A illustrates a longitudinal cross section of a double-tapered optical fiber that may be used in one embodiment of the optical spatial-mode filter of FIG. 1;

FIG. 4B is a block diagram illustrating another embodiment of the optical spatial-mode filter of FIG. 1;

FIG. 4C is a block diagram illustrating a mode-reconfigurable embodiment of the optical spatial-mode filter of FIG. 1;

FIG. 5 is a block diagram of an optical transmitter that uses the optical apparatus of FIG. 1, e.g., to perform optical spatial-mode multiplexing of data-modulated optical carriers;

FIG. 6 is a block diagram of an optical communication system that performs optical spatial-mode multiplexing of data-modulated optical carriers, e.g., using the optical transmitter of FIG. 5; and

FIG. 7 is a flow chart illustrating a method of performing optical spatial-mode multiplexing of data-modulated optical carriers, e.g., with the optical transmitter of FIG. 5 and/or the optical communication system of FIG. 6.

In the Figures and text, like reference symbols indicate elements with similar or the same function and/or structure.

In some of the Figures, the relative dimensions of some features may be exaggerated to more clearly illustrate one or more of the structures therein.

Herein, various embodiments are described more fully by the Summary of Some Example Embodiments, figures, and Detailed Description of Illustrative Embodiments. Nevertheless, the inventions may be embodied in various forms and are not limited to the embodiments described in the Summary of Some Example Embodiments, figures, and Detailed Description of Illustrative Embodiments.

### DETAILED DESCRIPTION OF ILLUSTRATIVE EMBODIMENTS

Herein, an optical spatial-mode multiplexer can excite a combination of optical propagating mode(s) of a multimode optical fiber in response to the receipt of light at one of its optical inputs provided that an end-face of the multimode optical fiber is suitably located with respect to the optical output of the multiplexer. When light is received at different ones of the optical inputs of the optical spatial-mode multiplexer, the different excited combinations have phase and/or amplitude distributions transverse to an axis of the multimode optical fiber that differ by more than a constant factor. Each such excited combination may be primarily a single optical propagating mode of an orthonormal set of such modes or may be a superposition of such orthonormal modes. The different excited combinations may or may not be approximately orthogonal.

Herein, an optical spatial-mode demultiplexer is an optical spatial-mode multiplexer, but is discussed as operated with light propagation directions reversed.

Herein, a multimode optical fiber has a complete orthonormal set of optical propagating modes that includes at least two such modes which differ by more than a polarization rotation.

The various embodiments include, at least, apparatus, systems, and methods configured to process light at wavelengths in one or more of the conventional optical telecommunications C, L, and S wavelength bands.

FIG. 1 illustrates an optical apparatus 10 that is capable of optically transmitting

N optical signal streams, in parallel, through an optical output OO to an adjacent and facing end-face 2 of a multimode optical fiber 6. The integer N is equal to or greater than 2. The optical apparatus 10 includes an optical spatial-mode multiplexer 12 and an optical spatial-mode filter 14. The optical spatial-mode multiplexer 12 has an array of N optical inputs I₁, . . . , I_{N} to receive the N individual optical signal streams and an optical output O, i.e., to which the N received individual optical signal streams are transmitted. The optical spatial-mode filter 14 end-connects to the adjacent optical output O of the optical spatial-mode multiplexer 12 and end-connects to the optical output OO of the optical apparatus 10. The optical apparatus 10 may optionally include collimating, focusing, and/or magnifying optics, e.g., bulk lens(es) and/or mirror(s), located between the optical output O of optical spatial-mode multiplexer 12 and the optical input of the optical spatial-mode filter 14 and/or located between the optical output OO of optical spatial-mode filter 14 and the end-face 2 of the multimode optical fiber 6.

The optical spatial-mode multiplexer 12 is configured to transmit each of the N optical signal streams, which are received at individual ones of the N optical inputs I₁-I_{N}, as a light pattern that excites a corresponding combination of one or more of the optical propagating modes of the multimode optical fiber 6 at the end-face 2 thereof. The different combinations have different phase and/or amplitude distributions on planes transverse to the axis of the multimode optical fiber 6, i.e., have linearly independent phase and/or amplitude distributions transverse to the axis. The different combinations may or may not be approximately orthogonal.

The optical spatial-mode multiplexer 12 may be a conventional free-space optical coupler or multiplexer, a photonic lantern coupler or multiplexer, or a 3D optical waveguide coupler or multiplexer. Examples of such conventional optical couplers or multiplexers may be described in one or more of U.S. Patent Application Publication Nos. 2014/0055843, 2013/0068937, 2012/0177384, 2011/0243574, 2011/0243490, and 2010/0329670 and/or U.S. patent application Ser. No. 13/78684. Various embodiments of the optical spatial-mode demultiplexer 12 may be may be constructed by combining the teachings of the present application with those of one or more of the above-cited U.S. Patent Application Publications and/or the above-cited U.S. patent application. The above-listed U.S. Patent Application Publications and the above-cited U.S. patent application are incorporated herein by reference in their entirety.

Due to fabrication and/or alignment imperfections, a conventional N×1 optical spatial-mode multiplexer would typically excite a plurality of the optical propagating modes of a multimode optical fiber end-connected thereto in response to an input of light to one of the N×1 optical spatial-mode multiplexer's N optical inputs. If the multimode optical fiber has many orthogonal optical propagating modes, some of the set of such excited optical propagating modes will often have significantly different phase velocities than the optical propagating modes primarily excited by such an N×1 optical spatial-mode multiplexer. When the transmission of an optical signal causes the excitation of optical propagating modes with very different velocities, the transmitted light can arrive, at the second end-face of the multimode optical fiber, with a large range of relative delays. Such a large range of relative arrival delays may interfere with the ability to demodulate the received optical signal, e.g., via conventional equalization and/or multiple-input-multiple-output (MIMO) techniques, at the far end-face of the multimode optical fiber. Indeed, the parallel excitation of optical propagating modes having significantly different velocities can put a strong upper limit on the useable length of the multimode optical fiber for optical data transmission and/or can put a strong upper limit on the optical data transmission rate in the multimode optical fiber.

In various embodiments, the optical spatial-mode filter 14 is constructed to reduce the excitation, by the optical spatial-mode multiplexer 12, of optical propagating modes with very different phase velocities in the multimode optical fiber 6. In particular, the optical spatial-mode filter 14 removes or strongly attenuates light having undesired lateral distributions, i.e., light coupling to the undesired optical propagating modes of the multimode optical fiber 6, and substantially passes light having desired lateral distributions, i.e., light coupling only to desired optical propagating modes of the multimode optical fiber 6. The desired light typically has vanishing overlap integrals with the undesired light over the cross sections of the optical input and optical output of the optical spatial-mode filter 14 and/or over the end-face of the multimode optical fiber 6. The desired light excites those optical propagating modes of the multimode optical fiber 6 whose velocities therein are in a preset range. The undesired light excites one or more of the optical propagating modes of the multimode optical fiber 6 whose velocities therein are outside of the same preset range.

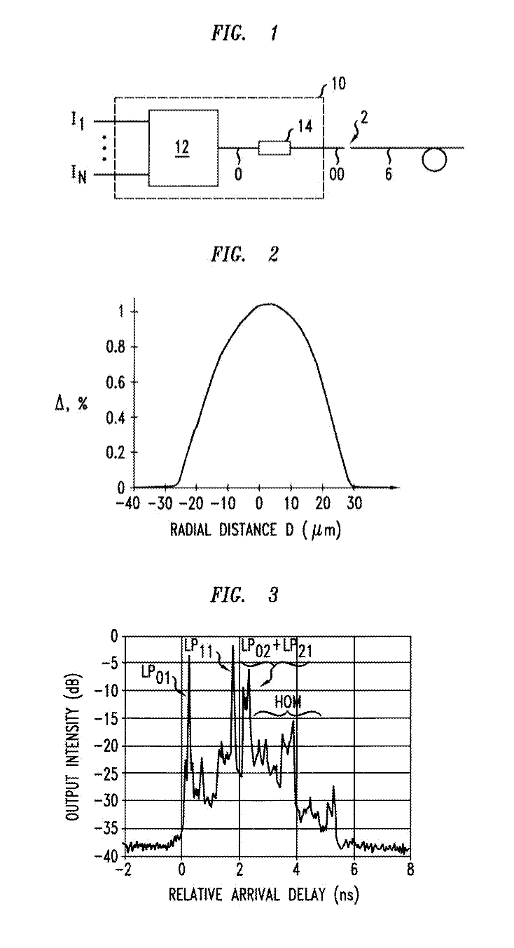

The optical spatial-mode filter 14 may be constructed to produce a preset range of phase velocities that is small enough to not impede the use of the multimode optical fiber 6, e.g., as a multimode optical communication link. For example, the optical spatial-mode filter 14 may be constructed to remove such undesired light by attenuating the light at least 10 dB more, preferentially at least 15 dB more, or even at least 20 dB more than the optical spatial-mode filter 14 attenuates light, which only excites the desired optical propagating modes of the multimode optical fiber 6. The strong attenuation of such undesired light may enable use of types of the multimode optical fiber 6 having many more propagating modes than conventional few mode optical fiber and still enable the resulting optical link to have a substantial length. The availability of such mode-selective and strong attenuation of undesired optical propagating modes may also enable future reconfigurations of the same multimode optical fiber 6 to carry optical data streams on more of or less of its optical propagating modes, i.e., thereby providing scalability in spatial-mode multiplexing. FIG. 2 shows the refractive-index profile of a cross section through an example optical fiber, which may be used as the multimode optical fiber 6 of FIG. 1. The example optical fiber has a graded-index optical core with a diameter of about 50 micrometers (μm). The illustrated refractive-index profile shows the percentage difference (Δ) between the refractive index of the optical core and the optical cladding as a function of distance (D) from the axis of the example optical fiber.

As an example, OM3+OM4 silica multimode optical fibers, which are sold by Corning of Ithaca N.Y. (www.corning.com) and are advertised under the trademark CLEAR CURVE®, may be used, e.g., for the multimode optical fiber 6 of FIG. 1.

Alternately, the multimode optical fiber 6 may have a radial refractive index profile that is similar to but differs from that of the OM3+OM4 silica multimode optical fibers sold by Corning. In particular, the radial refractive index profile may be modified to reduce or minimize differential group delay between various propagating modes of the multimode optical fiber 6 at a desirable optical communications wavelength, e.g., 1550 nanometers.

FIG. 3 is a plot illustrating impulse responses of one example of the multimode optical fiber 6 of FIG. 1. The plot shows output light intensities and relative delays for the light to traverse the example of the multimode optical fiber 6. The plot also includes labels for peaks corresponding to the LP₀₁, LP₁₁, LP₀₂, LP₂₁, and higher order LP modes (HOM) of the example of the multimode optical fiber 6. Notably, the relative arrive delay between the LP₀₁ and LP₁₁ modes is short, i.e., about 1.5 nano-seconds (ns), the relative arrival delay between the LP₀₁ mode and the LP₀₂ and LP₂₁ modes is longer, i.e., about 2 ns, and the relative arrival delay between the LP₀₁ mode and the HOMs is longest, i.e., greater than 2 ns. Thus, in this graded-index example of the multimode optical fiber 6, relative arrival delays roughly increase as the LP mode numbers increase.

For this example of the multimode optical fiber 6, the optical apparatus 10 of FIG. 1 may have different embodiments. In a first embodiment, the optical spatial-mode multiplexer 12 is able to transmit light to the LP₀₁ and LP₁₁ modes of the example of the multimode optical fiber 6 and to not significantly transmit light to the higher LP modes of the multimode optical fiber. In this first embodiment, the optical spatial-mode filter 14 is configured to pass light that couples to the LP₀₁ and LP₁₁ modes and to remove light that couples to the other LP modes, i.e., the LP₀₂ and LP₂₁ modes and the HOMs of FIG. 3. Thus, the preset range of velocities of the desired optical propagating modes in the multimode optical fiber 6 would result in relative arrival delays in the preset range of 1.5 ns at the far end-face of the example of the multimode optical fiber 6. In an alternate second embodiment, the optical spatial-mode multiplexer 12 is able to transmit light to the LP₀₁, LP₁₁, LP₀₂, and LP₂₁ modes of the example of the multimode optical fiber 6. In this second embodiment, the optical spatial-mode filter 14 is configured to pass light coupling to the LP₀₁, LP₁₁, LP₀₂, and LP₂₁ modes and to remove light that couples to the HOMs of FIG. 3. Thus, the preset range for velocities of the desired propagating modes in the example of the multimode optical fiber 6 would be larger than in the second embodiment and could cause relative arrival delays of up to 2 ns.

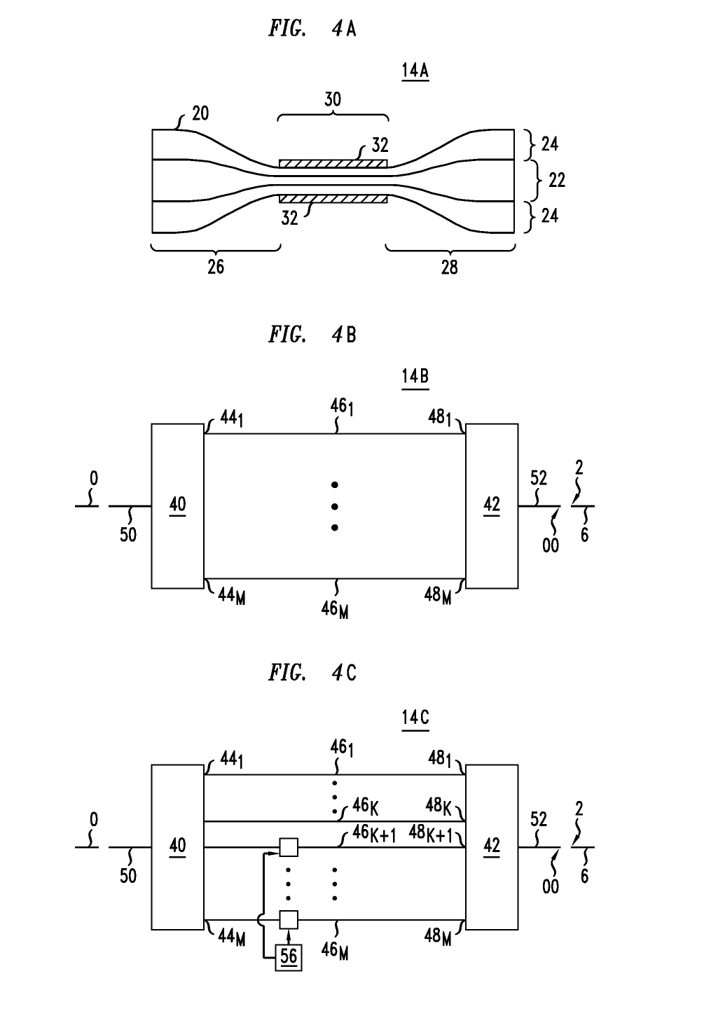

FIGS. 4A, 4B, and 4C illustrate various embodiments 14A , 14B, 14C of the optical spatial-mode filter 14 of FIG. 1.

Referring to FIG. 4A, the optical spatial-mode filter 14A includes a segment 20 of multimode optical fiber, which has an optical core 22 surrounded by an optical cladding 24. The segment 20 of multimode optical fiber has end segments 26, 28, which have tapers that gradually reduce the diameter of the optical core 22 away from the end-faces of the segment 20. The segment 20 also has a central sub-segment 30, which connects the two end segments 26, 28. In the central sub-segment 30, the optical core 22 and optical cladding 24 are thinner than in the end segments 26, 28 and have about constant diameters therein.

At the first end-face of the segment 20, the first end segment 26 may have, e.g., the same refractive index profile as the multimode optical fiber 6 of FIG. 1.

At the second end-face of the segment 20, the second end segment 28 may have a refractive index profile suitable for end-connecting to the optical output O of the optical spatial-mode multiplexer 12 of FIG. 1. For example, the profile may not cause any undesired distortion or mixing of optical spatial-modes propagating at the optical output O.

The first and second end segments 26, 28 may be reflection symmetric about the middle of the segment 20. For example, such a construction may be used when the optical output O of the optical spatial-mode multiplexer 12 of FIG. 1 is a segment of same type of multimode optical fiber as the multimode optical fiber 6 of FIG. 1.

In the segment 20, the central sub-segment 30 is configured to attenuate propagating light that would otherwise couple to the undesired optical propagating modes of the multimode optical fiber 6 of FIG. 1. In particular, in the central sub-segment 30, the optical core 22 is constructed to be narrower so that the optical core 22 guides less optical propagating modes than either the end segments 26, 28 or the multimode optical fiber 6 of FIG. 1. In the central sub-segment 30, the light carried by such unguided optical propagating mode(s) leaks from the optical core 22 to the optical cladding 24 and may then, leak out the side surface of the central sub-segment 30 thereby attenuating such unguided optical propagating mode(s). In the central sub-segment 30, the optical cladding 24 may also be thinner than in the end segments 26, 28, and the optical cladding 24 may also be surrounded by a second cladding material 32 of matching or relatively higher refractive index in the central sub-segment 30. Both such features typically will cause light from such unguided optical propagating modes to leak out of the optical claddings 24, 32 thereby being lost from the side surface of the optical mode-filter 14A. The central sub-segment 30 is constructed to be long enough to produce a preselected, desired amount of attenuation of such unguided optical propagating modes so that light of such modes does not significantly remain to later excite the undesired optical propagating modes of the multimode optical fiber 6 of FIG. 1.

In first and second examples, the central sub-segment 30 has different forms so that the optical spatial-mode filter 14A will function as the first and second embodiments of the optical spatial-mode filter 14, which were already described above with respect to FIG. 3. In the first embodiment, the optical core 22 of the central sub-segment 30 has a diameter that will only guide the optical propagating modes that only couple to the LP₀₁ and LP₁₁ modes of the above example of the multimode optical fiber 6 of FIG. 3. Then, those optical propagating modes that could excite the higher LP modes of FIG. 3, i.e., the LP₀₂ and LP₂₁ modes and the HOMs, are strongly attenuated in the central sub-segment 30. In the second embodiment, the optical core 22 of the central sub-segment 30 has a different diameter that will only the guide optical propagating modes that would only couple to the LP₀₁, LP₁₁, LP₀₂ and LP₂₁ modes of the example of the multimode optical fiber 6 of FIG. 3. Then, only the optical propagating modes that could excite the HOM modes of FIG. 3 are strongly attenuated in the central sub-segment 30.

For some graded-index multimode optical fibers, the inventors believe LP modes will have phase velocities and average distances from the fiber's axis that increase with mode number in a qualitatively regular manner. For such graded-index multimode optical fibers, the inventors believe it to be typically possible to design and construct a central sub-segment 30 of the optical spatial-mode filter 14A whose optical core 22 has a small enough diameter to not guide those optical propagating modes that would otherwise end-excite LP modes above a desired order in such a graded-index multimode optical fiber.

Referring to FIG. 4B, the optical spatial-mode filter 14B includes a 1×M optical spatial-mode demultiplexer 40 and an M×1 optical spatial-mode multiplexer 42, which are connected in a back-to-back manner. The 1×M optical spatial-mode demultiplexer 40 has M optical outputs 44₁, . . . , 44_{M} connected by M optical waveguides 46₁, . . . , 46_{M} to corresponding ones of the M optical inputs 48₁, . . . , 48_{M} of the 1×M optical spatial-mode multiplexer 42. The optical input 50 of the optical spatial-mode filter 14B is the optical input of the 1×M optical spatial-mode demultiplexer 40. The optical output 52 of the optical spatial-mode filter 14B is the optical output of the M×1 optical spatial-mode multiplexer 42.

The 1×M optical spatial-mode demultiplexer 40 and M×1 optical spatial-mode multiplexer 42 may be made as free-space optical devices, photonic lanterns, or 3D optical waveguide devices as already discussed with respect to the optical spatial-mode demultiplexer 12 of FIG. 1.

When operated for optical demultiplexing, the optical spatial-mode demultiplexer 40 and the optical spatial-mode multiplexer 42 may be, e.g., functionally identical optical devices. Thus, if the end-face 2 of the multimode optical fiber 6 of FIG. 1 is located adjacent to and facing the optical input 50 or the optical output 52, the optical spatial-mode demultiplexer 40 or multiplexer 42, as appropriate, will split the light received from the end-face 2 in about the same pattern, i.e., on the optical outputs 44₁-44_{M} or the optical inputs 48₁-48_{M}. But, if the end-face 2 of the multimode optical fiber 6 of FIG. 1 outputs light of the previously discussed, undesired optical propagating mode(s) therein, the optical spatial-mode demultiplexer 40 and multiplexer 42 are configured to transmit little or no light to the optical outputs 44₁-44_{M} or the optical inputs 48₁-48_{M}. For this reason, the back-to-back combination of the 1×M optical spatial-mode demultiplexer 40 and the optical spatial-mode multiplexer 42 is as an optical filter that selectively removes light, which is received from the undesired propagating modes of the multimode optical fiber 6 of FIG. 1 and passes light received from the desired optical propagating modes of multimode optical fiber 6 of FIG. 1.

The M optical waveguides 46₁, . . . , 46_{M} may pre-compensate and/or post-compensate for relative arrival delays between light carried by different ones of the optical propagating modes of the multimode optical fiber 6. As an example, different ones of the optical waveguides 46₁, . . . , 46_{M} may be connected to carry light coupling to relatively orthogonal propagating modes of the multimode optical fiber 6. In such embodiments, the optical waveguides 46₁, . . . , 46_{M} may have suitably differing lengths to pre-compensate and/or post-compensate such relative arrival delays, which are produced when light propagates through the multimode optical fiber 6.

FIG. 4C illustrates a reconfigurable optical spatial-mode filter 14C. The reconfigurable optical spatial-mode filter 14C and the optical spatial-mode filter 14B are similar, because both include the optical spatial-mode demultiplexer 40 and the optical spatial-mode multiplexer 42 connected in a back-to-back configuration in which the individual optical outputs 44₁-44_{M} are connected to corresponding ones of the individual optical inputs 48₁-48_{M}. In both devices 14B, 14C, the M optical outputs 44₁-44_{M} of the 1×M optical spatial-mode demultiplexer 40 will transmit light when the optical input 50 is configured to receive light of a first set of optical propagating modes via the adjacent and facing end-face 2 of the multimode optical fiber 6 of FIG. 1. In the spatial mode-filter 14C, only the K optical outputs 44₁-44ₖ of the 1×M optical spatial-mode demultiplexer 40 will transmit light when the optical input 50 receives light from a second set of optical propagating modes of the multimode optical fiber 6 of FIG. 1 via the adjacent and facing end-face 2 thereof. In the optical spatial-mode filter 14C, the K optical outputs 44₁-44_{K} connect via the optical waveguides 46₁-46ₖ to the corresponding K optical inputs 48₁-48_{K}, and the remaining (M-K) optical outputs 44_{K+1}-44_{M} connect via the (M-K) optical waveguides 46_{K+1}-46_{M} to the corresponding (M-K) optical inputs 48_{K+1}-48_{M}. Here, the second set is a proper subset of the first set.

The optical mode-filter 14C also includes one or more optical blocker(s) 54, e.g., variable optical attenuators, and an electronic controller connecter 56 connected to operate the optical blocker(s) 54. The one or more optical blockers 54 are located along segments of the (M-K) optical waveguides 46_{K+1}-46_{M}, which connect to the last (M-K) optical outputs 44_{K+1}-44_{M} of the optical spatial-mode demultiplexer 40. The optical outputs 44_{K+1}-44_{M} do not receive light from the second set of optical propagating modes of the multimode optical filter 6 when its end-face 2 is located adjacent and facing the optical input 50.

The electronic controller 30 operates the one or more the optical blocker(s) 54 to selectably be in a “pass state” or a “block state”. In the “pass state”, the optical blocker(s) 54 allow light to pass through the corresponding M-K optical waveguides 46_{K+1}-46_{M} so that all M of the optical waveguides 46₁-46_{M} of the optical spatial mode-filer 14C can transmit light between the optical spatial-mode demultiplexer 40 and the optical spatial-mode multiplexer 42. In the “block state”, the optical blocker(s) 54 strongly attenuate or block light in the (M-K) optical waveguides 46_{K+1}-46_{M} so that only the K optical waveguides 46₁-46_{K} can transmit light between the optical spatial-mode demultiplexer 40 and the optical spatial-mode multiplexer 42.

The “pass state” and the “block state” are filtering configurations of the optical spatial-mode filter 14C, which remove different sets of optical propagating modes of the multimode optical fiber 6 of FIG. 1. As an example, the 1×M optical spatial-mode demultiplexer 40 may be constructed to only transmit received light from the LP₀₁ and LP₁₁ modes of the example multimode optical fiber 6 of FIG. 3 to its first K optical outputs 44₁-44_{K} and to only transmit light received from the LP₀₂ and LP₂₁ modes of the example multimode optical fiber 6 of FIG. 3 to its last (M-K) optical outputs 44_{K+1}-44_{M}. Then, in the “pass state”, the optical spatial-mode filter 14C will pass light received from the LP₀₁, LP₁₁, LP₀₂, and LP₂₁ modes of the example multimode optical fiber 6 of FIG. 3 and will remove light received from the other LP modes of the example multimode optical fiber 6 of FIG. 3. In contrast, in the “block state”, the optical spatial-mode filter 14C will pass light received only from the LP₀₁ and LP₁₁ modes of the example multimode optical fiber 6 of FIG. 3 and will remove light received from the other LP modes of the example multimode optical filter 6 of FIG. 3. In the “block state”, the optical spatial-mode multiplexer 12 of FIG. 1 will also be configured to only transmit optical data streams from a subset of the N optical inputs I₁-I_{N}, e.g., from the optical data streams of the optical inputs I₁-I_{N} that are coupled to the smaller second set of optical propagating modes of the example multimode optical filter 6 of FIG. 3.

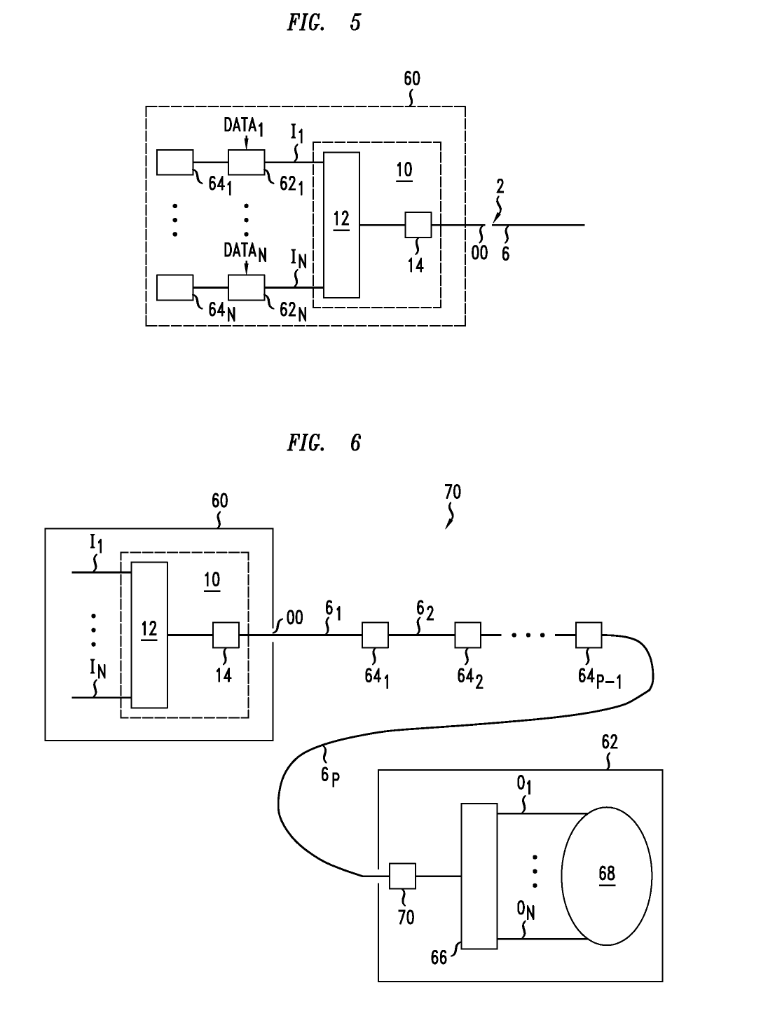

FIG. 5 illustrates an optical transmitter 60 that is configured to use spatial mode multiplexing. The optical transmitter 60 includes the optical apparatus 10 of FIG. 1 and also includes a parallel array of N optical data modulators 62₁-62_{N} and N corresponding optical sources 64₁-64_{N}. Each optical data modulator 62₁-62_{N} is optically connected to a corresponding one of the N optical inputs I₁-I_{N} of the optical spatial-mode multiplexer 12. Each individual optical modulator 62₁-62_{N} modulates a corresponding received digital data stream DATA₁, . . . , DATA_{N} onto an optical carrier received from the corresponding one of the optical sources 64₁-64_{N}.

Each optical data modulator 62₁-62_{N} may be, e.g., any conventional external optical modulator that is configured to modulate an optical carrier according to any known optical modulation format. Examples of suitable optical modulation formats include ON-OFF keying, binary phase shift keying (PSK), quadrature PSK, and quadrature amplitude modulation (QAM), e.g., 4 QAM, 8 QAM, 16 QAM, 32 QAM or 64 QAM.

The array of optical sources 64₁-64_{N} may include N different optical lasers or alternatively may only include a single optical laser if the output light from the single optical laser is split, e.g., intensity split, to provide N separate optical carriers to the N optical data modulators 62₁-62_{N}. The N optical sources 64₁-64_{N} may have the same or about the same optical wavelength, because the optical apparatus 10 uses N optical propagating modes of the multimode optical fiber 6 to carrier N parallel optical data streams rather than optical carriers of N different wavelengths.

In some embodiment, the optical transmitter 60 may also include a parallel array of Q of the arrays of the N optical sources 64₁-64_{N}, Q of the N optical data modulators 62₁-62_{N}, and Q of the optical apparatus 10 (not shown). The parallel structure of Q such arrays may provide for wavelength division multiplexing (WDM). For example, the embodiment may support Q/2 optical carrier wavelengths with polarization division multiplexing or Q optical carrier wavelengths without polarization division multiplexing as well the optical spatial-mode multiplexing already illustrated in the optical transmitter 60 in FIG. 5.

FIG. 6 illustrates an optical communication system 70 that transmits data via optical spatial-mode multiplexing. The optical communication system includes the optical transmitter 60, an optical receiver 70, and an all-optical series of P spans of multimode optical fiber 6₁, 6₂, . . . , 6_{P}. Here, P is an integer that is equal to or greater than one.

The optical transmitter 60 has already been described with respect to FIG. 5.

The P spans of multimode optical fiber 6₁, 6₂, . . . , 6_{P} are conventional multimode optical fibers, e.g., any of the above examples of the multimode optical fiber 6 of FIG. 1. Often, but not necessarily, the multimode optical fiber 6₁-6_{P} of each span may have about the same refractive index profile and thus, the series of P spans will have same set of optical propagating modes. Adjacent ones of the spans are connected by (P-1) all-optical processers 64₁, 64₂, . . . , 64_{P-1} that optically regenerate the received optical signals. Such optical regeneration may include any or all of optical amplification, optical dispersion compensation, and optical spatial-mode filtering to remove light propagating on the undesired optical propagating modes of the spans. Such inter-span optical spatial-mode filtering may be performed in an optical amplifier or a dispersion compensator that uses a few-mode optical fiber. For example, such a few-mode optical fiber may be constructed to not guide the undesired optical propagating modes. Alternately, such inter-span optical spatial-mode filtering may be performed in a device similar to or identical to the optical spatial-mode filter 14 of FIG. 1.

The optical receiver 62 is configured to receive the N optical signal streams from the end-face of the multimode optical fiber 6_{P} of the last or Pth span. The optical receiver 62 includes an optical spatial-mode demultiplexer 66, an electronic and/or optical processor 68, and optionally an optical spatial-mode filter 70.

The optical spatial-mode demultiplexer 66 may have a similar construction to the optical spatial-mode multiplexer 12 of the optical transmitter 60. The optical spatial-mode demultiplexer 66 spatial-mode splits the received light so that each optical output P₁, . . . , O_{N} receives light received from one of the N desired optical propagating modes of the multimode optical fiber 6ₚ. The processor 68 may perform, e.g., optical and/or electronic equalization and/or may perform electronic MIMO processing on the resulting N optical signal streams to remove mixing between the different data streams. For example, the optical receiver 62 may be configured to remove undesired optical spatial-mode mixing, which has been caused by imperfections, temperature, or mechanical changes in the P spans of the multimode optical fiber 6₁, 6₂, . . . , 6ₚ. The optional optical spatial-mode filter 70 may have a similar construction to the optical spatial-mode filter 14 in the optical transmitter 60. The optical spatial-mode filter 70 is configured to remove or strongly attenuate light received from the undesired optical propagating modes of the multimode optical fiber 6ₚ. Such optical spatial-mode filtering may further simplify processing, by the optical spatial-mode demultiplexer 66 and/or the processor 68, of light, which is received from the desired optical propagating modes of the multimode optical fiber 6_{P}.

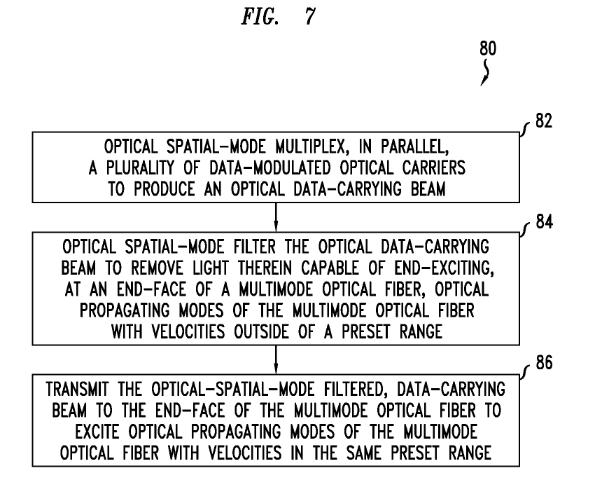

FIG. 7 illustrates a method 80 of optically communicating data via optical spatial-mode multiplexing, e.g., with the optical transmitter 60 of FIG. 5 and/or the optical communication system 70 of FIG. 6.

The method 80 includes optical spatial-mode multiplexing, in parallel, a plurality of data-modulated optical carriers to produce an optical data-carrying beam (step 82). For example, the step 82 may be performed by the optical spatial-mode multiplexer 12 of FIG. 6.

The method 80 includes optical spatial-mode filtering the optical data-carrying beam to remove light therein, which is capable of exciting, at the end-face of a multimode optical fiber optical propagating modes therein with velocities outside of a preset range (step 84). For example, the step 84 may be performed by optical spatial-mode filter 14 of FIG. 6.

The method 80 includes transmitting the optical spatial-mode filtered, data-carrying beam, i.e., produced at the step 84, to the end-face of the multimode optical fiber to excite optical propagating modes of the multimode optical fiber having velocities in the same preset range (step 86). For example, the transmitting step 86 may send the optical spatial-mode filtered, data-carrying beam to the end-face of the multimode optical fiber 6₁ of FIG. 6, which is nearest to, facing, and laterally aligned with the optical output OO of the optical transmitter 60.

In various embodiments, the method 80 may also include performing optical spatial-mode filtering of the transmitted, optical spatial-mode filtered, data-carrying light beam, after traversing one or more spans of the multimode optical fiber, e.g., a subset of the spans multimode optical fiber 6₁-6ₚ of FIG. 6. The performing may be configured to remove light carried by the optical propagating modes with velocities outside of a preset range. The optical spatial-mode filtering may be performed, e.g., in any of the all-optical processors 64₁, 64₂, . . . , 64_{P-1} and/or in the optical spatial-mode filter 70 of the optical data receiver 62 of FIG. 6.

In various embodiments, the method may also include optical spatial-mode demultiplexing of the transmitted, optical spatial-mode filtered, data-carrying light beam and performing equalization or MIMO processing of light beams produced by the demultiplexing to remove mode-mixing caused to the data-modulated optical carriers in the multimode optical fiber(s). The demultiplexing and processing may be performed, e.g., in the respective optical spatial-mode demultiplexer 66 and the processor 68 of the optical receiver 62 of FIG. 6.

In some embodiments the above-described apparatus and methods may involve exciting all LP modes of a multimode optical fiber, e.g., the optical fiber 6 of FIG. 1 or the optical fiber 6₁ of FIG. 6 up to a preselected LP mode number.

The inventions are intended to also include other embodiments that would be obvious to one of skill in the art in light of the description, figures, and claims.

What is claimed is:

1. An apparatus, comprising:
an optical spatial-mode multiplexer having a plurality of optical inputs and an optical output; and
an optical spatial-mode filter end-connected to the optical output of the optical spatial-mode multiplexer; and
wherein the optical spatial-mode filter is configured to end-connect to a multimode optical fiber having a set of optical propagation modes and is configured to pass the optical modes of the set whose velocities in the multimode optical fiber are within a selected range and to block remaining ones of the optical modes of the set.

2. The apparatus of claim 1, wherein the optical spatial-mode filter includes a segment of multimode optical fiber, the segment being tapered segments on both ends thereof.

3. The apparatus of claim 2, wherein a central segment of the segment of multimode optical fiber has an optical core of smaller diameter than segments at both ends of the segment of multimode optical fiber.

4. The apparatus of claim 1, further comprising
an optical transmitter capable of transmitting optical signal streams to the multimode optical fiber, in parallel, via optical spatial-mode multiplexing, the optical transmitter including an array of optical data modulators, each modulator of the array being optically connected to one of the optical inputs of the plurality.

5. The apparatus of claim 4, further comprising the multimode optical fiber and an optical data receiver connected to receive the optical signal streams from the optical transmitter via the multimode optical fiber.

6. The apparatus of claim 1, wherein the optical spatial-mode filter comprises an optical spatial-mode demultiplexer and an optical spatial-mode multiplexer connected in a back-to-back configuration.

7. The apparatus of claim 1, wherein the optical spatial-mode filter is electrically reconfigurable to only pass optical modes of a second set, the second set being a proper subset of the first set.

8. The apparatus of claim 1, wherein the optical spatial-mode filter is configured to attenuate light of the remaining ones of the optical modes of the set by at least 10 decibels more than light of the optical modes of the set whose velocities in the multimode optical fiber are within the selected range.

9. A system, comprising:
an optical transmitter configured to transmit optical signals via optical spatial-mode multiplexing; and
at least, one span of multimode optical fiber having a near end connected to receive the transmitted optical signals from the optical transmitter and having a set of optical propagating optical modes; and
wherein the system is configured to transmit optical signals via the multimode optical fiber over a proper subset of the set of propagating optical modes without significantly exciting those of the optical propagating modes outside the proper subset, the proper subset including the optical propagating modes of the set having optical velocities in a selected interval.

10. The system of claim 9, wherein the optical transmitter includes an optical spatial-mode filter configured to attenuate light on the optical propagating modes outside the proper subset by at least 10 decibels more than light on the optical propagating modes in the proper subset.

11. The system of claim 9, wherein the optical data transmitter includes an optical spatial-mode filter configured to block light on the optical propagating modes outside of the proper subset.

12. The system of claim 11, wherein the optical data transmitter includes an optical spatial-mode multiplexer serially connected to an optical spatial-mode filter.

13. The system of claim 12, wherein the at least, one span of multimode optical fiber has a far end connected to transmit light therein to an all-optical processor that selectively attenuates light on the optical propagating modes outside the proper subset more than light on the optical propagating modes in the proper subset.

14. The system of claim 9, further comprising an optical data receiver connected to receive the transmitted optical signals via the multimode optical fiber and to perform multiple-input-multiple-output processing or equalization of light received from the multimode optical fiber based on only those of the spatial-optical modes in the proper subset.

15. A method, comprising:
optical spatial-mode multiplexing, in parallel, a plurality of data-modulated optical carriers to produce an optical data-carrying beam;
optical spatial-mode filtering the optical data-carrying beam to remove light capable of exciting, at the end-face of a multimode optical fiber optical propagating modes with velocities outside of a preset range; and
transmitting the optical spatial-mode filtered, data-carrying beam to the end-face to excite optical propagating modes of the multimode optical fiber having velocities in the preset range.

16. The method of claim 15, further comprising
performing optical spatial-mode filtering of the transmitted, optical spatial-mode filtered, data-carrying beam after said transmitted, optical spatial-mode filtered data-carrying beam bean has traversed one or more spans of the multimode optical fiber.

17. The method of claim 16, wherein the performing is configured to remove light carried by the optical propagating modes with velocities outside of a preset range.

18. The method of claim 15, further comprising optical spatial-mode demultiplexing the transmitted, optical spatial-mode filtered, data-carrying light beam and performing equalization or MIMO processing of light beams produced by the optically spatial-mode demultiplexing.
